(19) United States
(12) Patent Application Publication
(10) Pub. No.: US 2005/0025282 A1
(43) Pub. Date: Feb. 3, 2005

(54) Apparatus with a rotationally driven rotary body

(76) Inventors: Jorg Freudenberger, Baiersdorf (DE); Wolfgang Kutschera, Aurachtal (DE); Peter Schardt, Hochstadt (DE)

Correspondence Address: SCHIFF HARDIN, LLP;PATENT DEPARTMENT, 6600 SEARS TOWER, CHICAGO, IL, 60606-6473, US

(21) Appl. No.: 10/891,206

(22) Filed: Jul. 14, 2004

(30) Foreign Application Priority Data
Jul. 14, 2003 (DE) 103 31 807.0

(51) Int. Cl. H05H 1/00; H01J 35/00; G21G 4/00

(52) U.S. Cl. 378/119

(57) ABSTRACT

An apparatus has a housing with a rotationally driven rotary body mounted to rotate in the housing, and at least one rotationally driven rotary conductor body, mounted to rotate in the housing and around the rotary body. The rotary conductor body is driven at a rotational frequency that differs from the rotational frequency of the rotary body.

### BACKGROUND OF THE INVENTION

1. Field of the Invention

The present invention concerns an apparatus with a rotary body that is arranged such that it is rotationally driven in a housing. Rotary bodies are used, for example, in actuator technology and in cooling technology. A further example of such an apparatus is an x-ray radiator with a rotary piston tube as a rotary body.

2. Description of the Prior Art

Rotary piston tubes or x-ray radiators with rotary piston tubes are, among other things, described in U.S. Pat. Nos. 6,084,942 and 6,364,527, and 6,396,901 and 5,579,364. The rotary piston tube is normally positioned in the radiator housing such that it can rotate around its longitudinal axis, and in operation is rotated around its longitudinal axis by a suitable drive system, for example an electromotor. The anode of the rotary piston tube is fixed to the vacuum housing of the tube or forms a part of the vacuum housing. The electron beam emitted in operation by the cathode (likewise fixed to the vacuum housing) is deflected by a suitable deflection system that is stationary relative to the rotary piston tube, such that a focal spot that is stationary relative to the radiator housing is created on the incident surface of the anode. New cold or cooled locations of the anode are thus always struck by the electron beam. The thermal capacity of the focal spot is thus significantly higher than with an x-ray tube with an anode at rest relative to the electron beam.

So that the rotary piston tube is sufficiently cooled, the radiator housing is normally filled with a fluid as coolant.

For improved cooling of the rotary piston tube, the x-ray radiators disclosed in U.S. Pat. Nos. 6,084,942 and 6,396,901 are provided with fixed conductor bodies that direct the coolant to the rotary piston tube.

To reduce the friction losses within the coolant, in the x-ray radiator known from U.S. Pat. No. 6,364,527 the rotary piston tube is fixed in a coolant housing that rotates together with the rotary piston tube. Particularly given relatively long x-ray exposure times, the cooling is worse, due to a lesser heat transfer, than in the x-ray radiators known from U.S. Pat. Nos. 6,084,942 and 6,396,901.

In the x-ray radiator described in U.S. Pat. No. 5,579,364, cooling ensues through fluid loops. The part of the rotary piston tube adjacent to the anode, however, is cooled relatively little and can be thermally stressed more severely by scattered electrons.

### SUMMARY OF THE INVENTION

An object of the present invention to provide an apparatus of the above general type wherein the rotary body is better cooled.

This object is achieved in accordance with the invention by an apparatus having a housing, a rotationally driven rotary body mounted in the housing such that it can rotate, and at least one rotary-driven conductor body mounted such that it can rotate in the housing around the rotary body, the conductor body having a rotational frequency different than the rotational frequency of the rotary body. The rotary body and the rotary conductor body, according to different embodiments of the inventive apparatus, are each driven with a separate actuator or are both connected with one actuator via transmission containing gears or the like to produce the different rotational frequencies. Moreover, according to an advantageous variant of the inventive apparatus, the rotational frequency of the rotary body and/or the rotational frequency of the rotary conductor body can be adjusted (varied). The rotary conductor body preferably rotates with a lower rotational frequency than the rotary body.

Due to the rotational frequency difference between the rotary body and the rotary conductor body, turbulences that lead to an improved heat transfer, and thus have the result of an improved cooling of the rotary body, are intentionally produced in the fluid filling the housing according to a preferred embodiment of the inventive apparatus. The rotary body thus is optimally, completely cooled by the fluid serving as a coolant, which is, for example, an oil.

In a further embodiment of the inventive apparatus, a fluid is disposed between the rotary body and the rotary conductor body, and a medium that exhibits a lower viscosity than the fluid is disposed between the rotary conductor body and the housing. The medium of lower viscosity is preferably a gas, in particular sulfur hexafluoride, air or a mixture of hydrocarbon, SF6 and air. Moreover, a vacuum can be present outside of the rotary conductor body.

In another embodiment of the inventive apparatus, the rotary conductor body is coaxially positioned with regard to the rotary body. In a further embodiment the rotary conductor body is two-part or multi-part.

If the apparatus is an x-ray radiator, i.e. if the rotary body is a rotary piston tube, then the common rotation of rotary conductor body and rotary piston tube in the medium of lower viscosity or vacuum enables a relatively short exposure time with relatively high x-ray radiation capacity, because the anode can be moved with a relatively high rotational speed (angular velocity) relative to the electron beam. Moreover, in comparison to the x-ray radiators known from U.S. Pat. Nos. 6,084,942 and 6,396,901, such an x-ray radiator requires unchanged or decreased drive capacity.

According to a further embodiment, the apparatus is an x-ray radiator in which the rotary body constitutes an x-ray tube with a cathode that can be rotated relative to the x-ray tube and a stationary anode.

### DESCRIPTION OF THE DRAWINGS

FIG. 1 is a section through an x-ray radiator having a rotary piston tube and a rotary conductor body in accordance with the invention that are connected with a transmission.

FIG. 2 is a section through an x-ray radiator with a rotary piston tube and a rotary conductor body in accordance with the invention, which are individually driven separate actuators.

### DESCRIPTION OF THE PREFERRED EMBODIMENTS

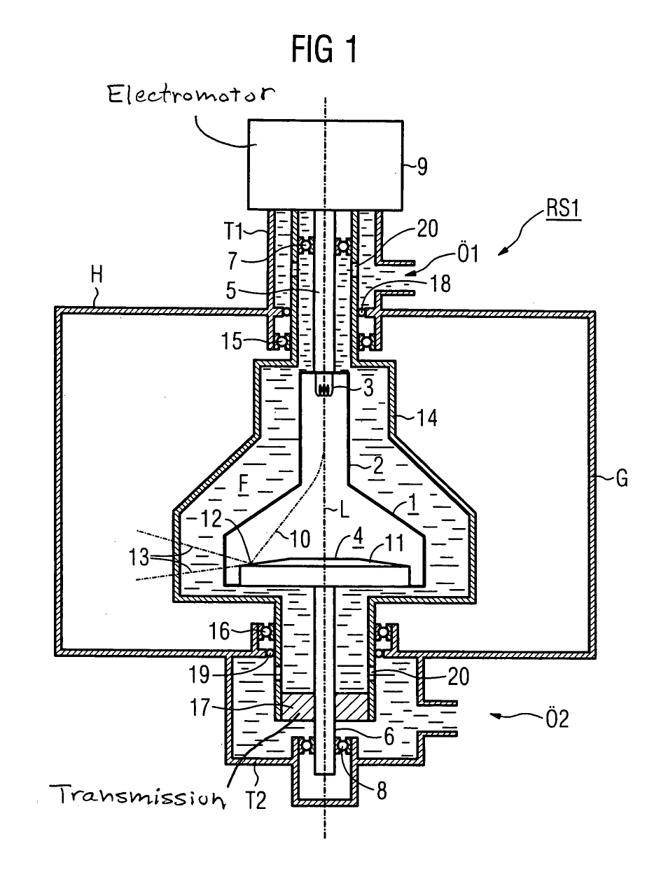

FIG. 1 shows an inventive apparatus in the form and x-ray radiator RS1 with a rotary piston tube 1 as a rotary body. The rotary piston tube 1 has a rotationally symmetrical vacuum housing 2, inside of which a cathode 3, that can be electrically contacted from the outside with a slip ring (not shown in FIG. 1), is fixed. In the exemplary embodiment, a frustrum-shaped anode 4 forms a part of the vacuum housing 2 of the rotary piston tube 1. In operation, the cathode 3 and the anode 4 rotate in common with the vacuum housing 2 around its longitudinal axis L. In the shown example, the longitudinal axis L proceeds through the cathode 3 and the anode 4.

To allow the rotary piston tube 1 to rotate around its longitudinal axis L, shafts 5 and 6 respectively extend through opposite ends of the vacuum housing 2 of the rotary piston tube 1. The longitudinal axes of the shafts 5 and 6 coincide with the longitudinal axis L of the vacuum housing 2 of the rotary piston tube 1. The shafts 5 and 6 are respectively mounted so they can rotate with ball bearings 7 and 8. At the free end of the shaft 5, an electromotor (schematically indicated) is connected that, in the exemplary embodiment, in operation rotates the rotary piston tube 1 around its longitudinal axis L with a variable rotational frequency.

Because, in operation of the rotary piston tube 1, the cathode 3 and the anode 4 rotate together with the vacuum housing 2, the x-ray radiator RS1 has an election beam deflection system (not shown in detail in FIG. 1, and for example of a type known from U.S. Pat. Nos. 6,084,942 or 6,364,527 or 6,396,901 or 5,579,364) that deflects an electron beam 10 originating from the cathode 3 such that the electron beam 10 strikes on an annular incident surface 11 of the anode 4 in a focal spot 12 stationary relative to the radiator housing G of the x-ray radiator. From this focal spot 12 an x-ray beam (shown dash-dot) is emitted.

In the exemplary embodiment, a piston-shaped rotary conductor body 14 is disposed around the rotary piston tube 1. In the exemplary embodiment, the rotary conductor body 14 is composed of aluminum or an aluminum alloy.

The rotary conductor body 14 also is mounted at both ends thereof with ball bearings 15 and 16 such that it can rotate relative to its longitudinal axis that, in the exemplary embodiment, coincides with the longitudinal axis L of the rotary piston tube 1. At the anode-side end of the rotary piston tube 1, the rotary conductor body 14 is connected with the anode-side shaft of the rotary piston tube 1 via a (gearing) transmission 17. By means of the transmission 17, the rotary conductor body 14 is rotationally driven together with the rotary piston tube 1, but with a rotational frequency different than the rotational frequency of the rotary piston tube 1. In the exemplary embodiment, the transmission 17 reduces the rotational frequency of the rotary conductor body 14 to a lower rotational frequency composed to the rotary piston tube 1.

The rotary conductor body 14 and the rotary piston tube 1 are disposed in a stationary radiator housing G, i.e., they are (as shown in FIG. 1) supported by the ball bearings 5 and 6, or the ball bearings 15 and 16, such that they can rotate relative to the radiator housing G.

In the exemplary embodiment, the radiator housing G is composed of three parts and includes a main housing H and two sub-housings T1 and T2. The sub-housing T1 surrounds the shaft 5 and the housing part T2 surrounds the shaft 6. The sub-housings T1 and T2 respectively have openings O1 and O2 with which the radiator housing G is connected to an external cooling circuit (not shown in FIG. 1), which in turn includes heat exchangers (not shown).

In order to cool the rotary piston tube 1 in operation, the rotary conductor body 14 is filled with a fluid F as a coolant, which is normally an oil especially suited for cooling. Moreover, the rotary conductor body 14 is provided with bores in the regions in which it rotates within the sub-housings T1 and T2, and is thus permeable for the fluid F, such that the fluid F that is heated due to the heating of the rotary piston tube 1 can be cooled via the openings O1 and O2 in the sub-housings T1 and T2 by means of the external cooling circuit.

By contrast, in the exemplary embodiment the main housing H of the radiator housing G is filled with sulfur hexafluoride, which exhibits a lower viscosity than the fluid F located within the rotary conductor body 14. To prevent the sulfur hexafluoride from leaking from the main housing H of the radiator housing G into the sub-housings T1 or T2, and to prevent the fluid F from permeating into the main housing H, in this example the main housing H is sealed from the rotary conductor body 14 and the sub-housings T1 and T2 with shaft seals 18 and 19.

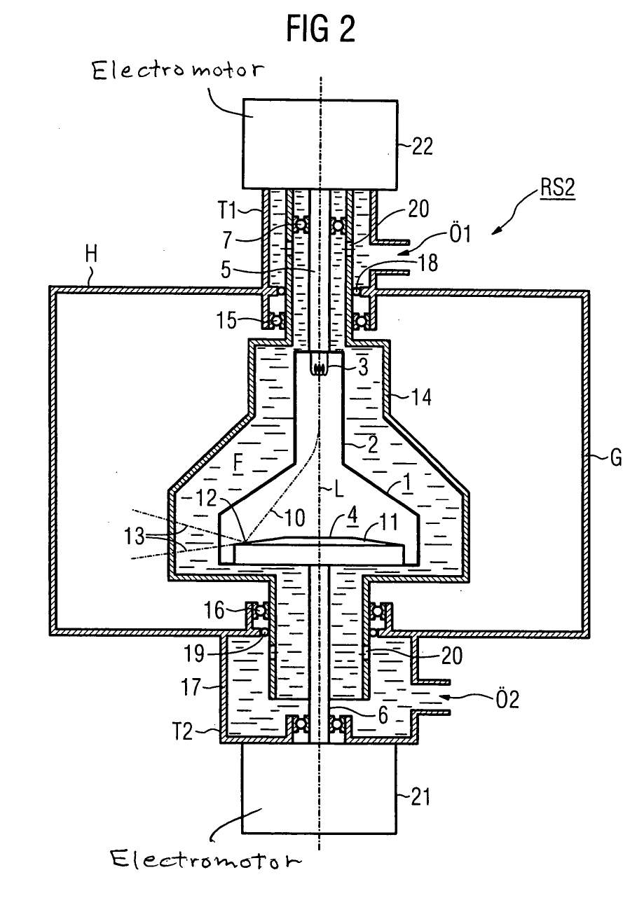

FIG. 2 shows a further embodiment of an inventive apparatus in the form of an x-ray radiator RS2 with a rotary piston tube 1 as a rotary body. In the following, corresponding parts of both of the x-ray radiators RS1 and RS2 shown in FIG. 1 and 2 are provided with the same reference characters. Moreover, identical parts of both x-ray radiators are not explained in detail again.

In contrast to the x-ray radiator RS1 shown in FIG. 1, the rotary piston tube 1 of the x-ray radiator RS2 is placed in rotation by a schematically indicated electromotor 21 that is arranged on the anode-side shaft 6 of the rotary piston tube 1.

Furthermore, the rotary conductor body 14 of the x-ray radiator RS2 shown in FIG. 2 is not connected with the rotary piston tube 1 via a transmission, but instead the cathode-side end of the rotary conductor body 14 is connected with another electromotor 22 that drives the rotary conductor body 14 with a rotational frequency that is different from the rotational frequency of the electromotor 21 for the rotary piston tube 1. In the exemplary embodiment, the rotational frequencies of the electromotors 21 and 22 can be variably adjusted and also adjusted independently of one another, such that the rotary conductor body 14 and the rotary piston tube 1 can be operated with respective variable rotational frequencies. In the present exemplary embodiment, the rotary conductor body 14 is operated with a lower rotary frequency than the rotational piston tube 1.

In the specified exemplary embodiments, the rotary conductor body 14 is a one-piece component, but two-piece and multi-piece rotary conductor bodies are also suitable.

It is also not necessary that the rotary conductor body 14 be positioned coaxially to the rotary piston tube 1.

The rotary piston tube 1 shown in FIGS. 1 and 2 alternatively can be fashioned such that its cathode is mounted so as to rotate relative the vacuum housing; with the anode stationary, as is known from, for example, U.S. Pat. No. 5,046,186.

The rotary piston tube 1 is an example from medical technology. The inventive apparatus also can be used in other technical fields, in particular actuator technology or cooling technology, wherein the rotary body is not a rotary piston tube.

Although modifications and changes may be suggested by those skilled in the art, it is the intention of the inventors to embody within the patent warranted hereon all changes and modifications as reasonably and properly come within the scope of their contribution to the art.

1. An apparatus comprising:
a housing;
a rotationally driven rotary body mounted in said housing for rotation in said housing; and
a rotationally driven rotary conductor body mounted in said housing for rotation in said housing around said rotary body, said rotary conductor body being driven with a rotational frequency differing from a rotational frequency at which said rotary body is driven.

2. An apparatus as claimed in claim 1 comprising a single actuator mechanically connected to each of said rotary body and said rotary conductor body for driving both of said rotary body and said rotary conductor body.

3. An apparatus as claimed in claim 2 comprising a transmission connected between said rotary body and said rotary conductor body for causing said rotary conductor body to be driven at said rotational frequency that differs from the rotational frequency of said rotary body.

4. An apparatus as claimed in claim 2 wherein said actuator is variable for varying the rotational frequency of at least one of said rotary body and said rotary conductor body.

5. An apparatus as claimed in claim 1 comprising a first actuator mechanically connected to said rotary body for rotating said rotary body, and a second actuator mechanically connected to said rotary conductor body for rotating said rotary conductor body.

6. An apparatus as claimed in claim 5 wherein at least one of said first actuator and said second actuator is variable for varying the rotational frequency of at least one of said rotary body and said rotary conductor body.

7. An apparatus as claimed in claim 1 comprising a fluid filling an interior of said housing.

8. An apparatus as claimed in claim 1 comprising a fluid filling a volume between said rotary body and said rotary conductor body, and a medium exhibiting a lower viscosity than said fluid filling an interior of said housing.

9. An apparatus as claimed in claim 1 wherein said rotary body and said rotary conductor body are mounted in said housing for coaxial rotation.

10. An apparatus as claimed in claim 1 wherein said rotary conductor body is composed of at least two parts.

11. An apparatus as claimed in claim 1 wherein said rotary body is an x-ray tube having a cathode and an anode mounted stationary relative to said x-ray tube.

12. An apparatus as claimed in claim 1 wherein said rotary body is an x-ray tube having a cathode that is rotatable relative to said x-ray tube and an anode that is stationary relative to said x-ray tube.
